(19) United States
(12) Patent Application Publication
(10) Pub. No.: US 2024/0070912 A1
(43) Pub. Date: Feb. 29, 2024

(54) IMAGE PROCESSING APPARATUS, INFORMATION PROCESSING METHOD, AND STORAGE MEDIUM

(71) Applicant: CANON KABUSHIKI KAISHA, Tokyo (JP)

(72) Inventor: Kenshi SAITO, Kanagawa (JP)

(21) Appl. No.: 18/448,204

(22) Filed: Aug. 11, 2023

(30) Foreign Application Priority Data
Aug. 31, 2022 (JP) 2022-138343

(51) Int. Cl. G06T 7/73; G06T 7/11; G06T 7/174; G06T 7/246; G06T 7/77

(52) U.S. Cl. CPC G06T 7/74; G06T 7/11; G06T 7/174; G06T 7/248; G06T 7/77; G06T 2207/20076; G06T 2207/20081

(57) ABSTRACT

There is provided with an information processing apparatus. A first obtaining unit obtains a position and a size of a subject from an area of interest of a first frame by using a first estimation unit. A second obtaining unit obtains the position and the size of the subject in the first frame that a second estimation unit has estimated based on the position obtained by the first obtaining unit from the area of interest of the first frame. A first deciding unit decides an area of interest in a second frame which follows the first frame by using the position and the size obtained by the first obtaining unit and the position and the size obtained by the second obtaining unit.

### BACKGROUND

### Field

The present disclosure relates to an image processing apparatus, an information processing method, and a storage medium.

### Description of the Related Art

A technique for tracking a subject obtained by extracting a specific subject image from an image supplied in time series is used for specifying a face area, a body area, or the like of a human in a moving image. The technique for tracking a subject can be used in many fields, such as teleconferencing, man-machine interfaces, security, monitoring systems for tracking any subject, image compression, and the like.

The technique for tracking a subject may be used to optimize focus conditions and exposure conditions for a subject. In Japanese Patent Laid-Open No. 2001-60269, a technique for automatically tracking a specific subject using template matching is disclosed. Further, in Japanese Patent Laid-Open No. 2014-7775, a technique is disclosed in which a subject is detected using a detection unit that is different from a tracking unit, and in a case where a predetermined condition is satisfied, a detection result by the detection unit is used as a tracking result of the subject, so that more accurate tracking is attempted.

### SUMMARY

According to one embodiment of the present disclosure, an information processing apparatus comprises: a first obtaining unit configured to obtain a position and a size of a subject from an area of interest of a first frame by using a first estimation unit trained so as to estimate a position and a size of a subject from an area of interest of each frame of a moving image; a second obtaining unit configured to obtain the position and the size of the subject in the first frame that a second estimation unit, which is trained so as to estimate a size and a position of a subject in a still image, has estimated based on the position obtained by the first obtaining unit from the area of interest of the first frame; and a first deciding unit configured to decide an area of interest in a second frame which follows the first frame by using the position and the size obtained by the first obtaining unit and the position and the size obtained by the second obtaining unit.

According to another embodiment of the present disclosure, an information processing method comprises: obtaining a position and a size of a subject from an area of interest of a first frame by using a first estimation unit trained so as to estimate a position and a size of a subject from an area of interest of each frame of a moving image; obtaining the position and the size of the subject in the first frame that a second estimation unit, which is trained so as to estimate a size and a position of a subject in a still image, has estimated based on the position obtained by using the first estimation unit from the area of interest of the first frame; and deciding an area of interest in a second frame which follows the first frame by using the position and the size obtained by using the first estimation unit and the position and the size estimated by the second estimation unit.

According to yet another embodiment of the present disclosure, an image processing method comprises: obtaining a position and a size of a subject from an area of interest of a first frame by using a first estimation unit trained so as to estimate a size and a position of a subject from an area of interest of each frame of a moving image; obtaining the position and the size of the subject in the first frame that a second estimation unit trained so as to estimate a size and a position of a subject in a still image has estimated based on the position obtained by the first obtaining unit from the area of interest of the first frame; and deciding the size and the position of the subject in the first frame by correcting the position and the size obtained by using the first estimation unit with the position and the size estimated by the second estimation unit.

According to still another embodiment of the present disclosure, a non-transitory computer-readable storage medium stores a program which, when executed by a computer comprising a processor and a memory, causes the computer to: obtain a position and a size of a subject from an area of interest of a first frame by using a first estimation unit trained so as to estimate a position and a size of a subject from an area of interest of each frame of a moving image; obtain the position and the size of the subject in the first frame that a second estimation unit, which is trained so as to estimate a size and a position of a subject in a still image, has estimated based on the position obtained by using the first estimation unit from the area of interest of the first frame; and decide an area of interest in a second frame which follows the first frame by using the position and the size obtained by using the first estimation unit and the position and the size estimated by the second estimation unit.

According to yet still another embodiment of the present disclosure, a non-transitory computer-readable storage medium stores a program which, when executed by a computer comprising a processor and a memory, causes the computer to: obtain a position and a size of a subject from an area of interest of a first frame by using a first estimation unit trained so as to estimate a size and a position of a subject from an area of interest of each frame of a moving image; obtain the position and the size of the subject in the first frame that a second estimation unit trained so as to estimate a size and a position of a subject in a still image has estimated based on the position obtained by the first obtaining unit from the area of interest of the first frame; and decide the size and the position of the subject in the first frame by correcting the position and the size obtained by using the first estimation unit with the position and the size estimated by the second estimation unit.

Further features of the present disclosure will become apparent from the following description of exemplary embodiments (with reference to the attached drawings).

### BRIEF DESCRIPTION OF THE DRAWINGS

FIG. 1 is a view illustrating an example of a functional configuration of an image processing apparatus according to a first embodiment.

FIG. 2 is a flowchart illustrating an example of information processing according to the first embodiment.

FIG. 3 is a view for describing area of interest decision processing according to the first embodiment.

FIG. 4A and FIG. 4B are views for describing area of interest decision processing according to the first embodiment.

FIG. 5A and FIG. 5B are views for describing tracking processing according to the first embodiment.

FIG. 6 is a view illustrating an example of a functional configuration of an image processing apparatus according to a second embodiment.

FIG. 7 is a flowchart illustrating an example of information processing according to the second embodiment.

FIG. 8 is a view for describing decision processing of a tracking target according to the second embodiment.

FIG. 9 is a view illustrating an example of a hardware configuration of an image processing apparatus.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

In Japanese Patent Laid-Open No. 2014-7775, the detection result of each of the tracking unit and the detection unit is exclusively selected in accordance with a predetermined determination criterion. Therefore, the detection result by the detection unit was not reflected in the detection result by the tracking unit as necessary.

A goal of the present disclosure is to improve tracking accuracy by improving size estimation accuracy of a subject by a tracker.

### First Embodiment

The image processing apparatus according to the present embodiment obtains a position and a size of a subject from an area of interest of a first frame by using a first estimation unit trained so as to estimate the position and the size of the subject from the area of interest of each frame in a moving image. Next, the image processing apparatus obtains the position and the size of the subject in the first frame estimated, by a second estimation unit trained so as to estimate the position and the size of the subject in a still image, based on the position obtained by the first estimation unit from the area of interest of the first frame. Further, the position and the size obtained by the first estimation unit and the position and the size obtained by the second estimation unit are used to decide the area of interest in the second frame which follows the first frame.

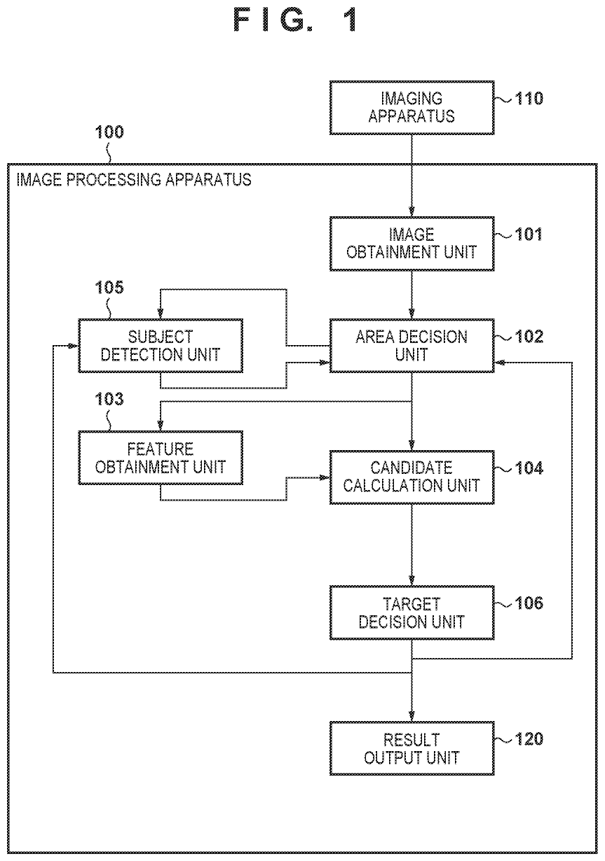

FIG. 1 is a block diagram illustrating an example of a functional configuration of an image processing apparatus 100 according to the present embodiment. The image processing apparatus 100 according to the present embodiment includes an image obtainment unit 101, an area decision unit 102, a feature amount obtainment unit 103, a candidate calculation unit 104, a subject detection unit 105, and a target decision unit 106. It is assumed that the image processing apparatus 100 according to the present embodiment is communicably connected to an imaging apparatus 110 and a result output unit 120.

The imaging apparatus 110 according to the present embodiment is, for example, an apparatus having an imaging function such as a digital camera, a surveillance camera, or a smartphone, and obtains a captured image. The image processing apparatus 100 according to the present embodiment may be an apparatus built into the imaging apparatus 110, or may be an apparatus separate from the imaging apparatus 110 such as a personal computer or a server.

The image obtainment unit 101 obtains an image to be processed. The image obtainment unit 101 according to the present embodiment can obtain time-continuous captured images (moving images) that are captured by the imaging apparatus 110. Note that the image obtainment unit 101 may obtain a moving image stored in the storage apparatus or may obtain a moving image via a network. Hereinafter, the term “image” will be used without distinction between a moving image and a still image included in the moving image.

The area decision unit 102 decides an area of interest for detecting a subject to be tracked from an image. Here, the area of interest is a partial area set in an image for detecting a subject, and is referred to as a common area in a tracking unit and a detection unit which will be described later in the present embodiment. The processing of deciding the area of interest according to the present embodiment will be described later.

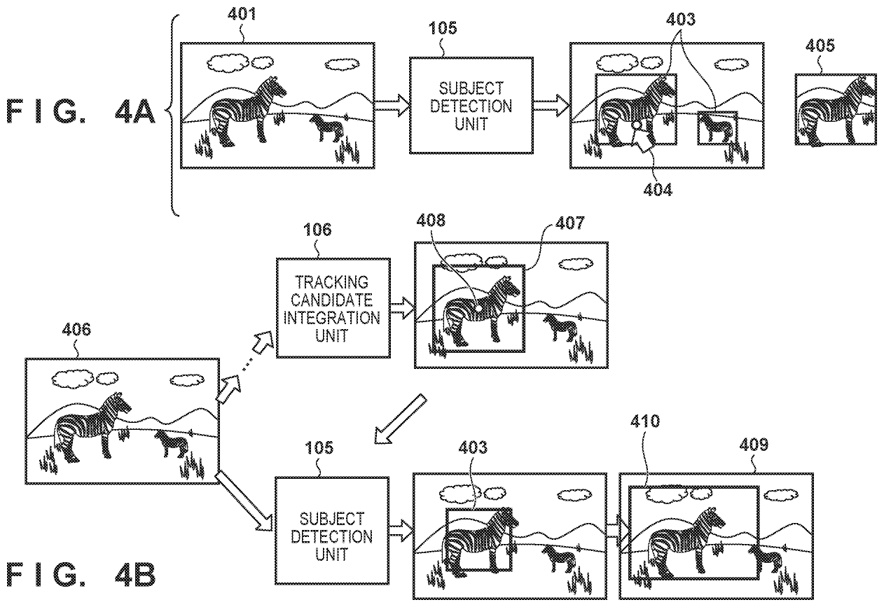

Further, the area decision unit 102 sets a template area, which is a partial area for extracting the template feature amount, on the image. The feature amount obtainment unit 103 can extract a template feature amount used when detecting a candidate to be tracked from the template area. FIG. 4A is a view illustrating an example of a template area set in the present embodiment.

In FIG. 4A, two detection results 403 are detected by the subject detection unit 105, which will be described later, in an inputted image 401. In this example, one of the detection results 403 is designated by a designation 404 by the user, and the inside of the designated area is cut out and extracted as an image of interest 405. Here, the detection result 403 having the closest center position to the position of the designation 404 by the user is set as a template area. The template area set here is an area indicating a subject detected by the area decision unit 102, but the setting method is not particularly limited as described above. For example, a candidate subject may be scored by a known detection technique, and the area decision unit 102 may set a candidate area having the highest score as a template area.

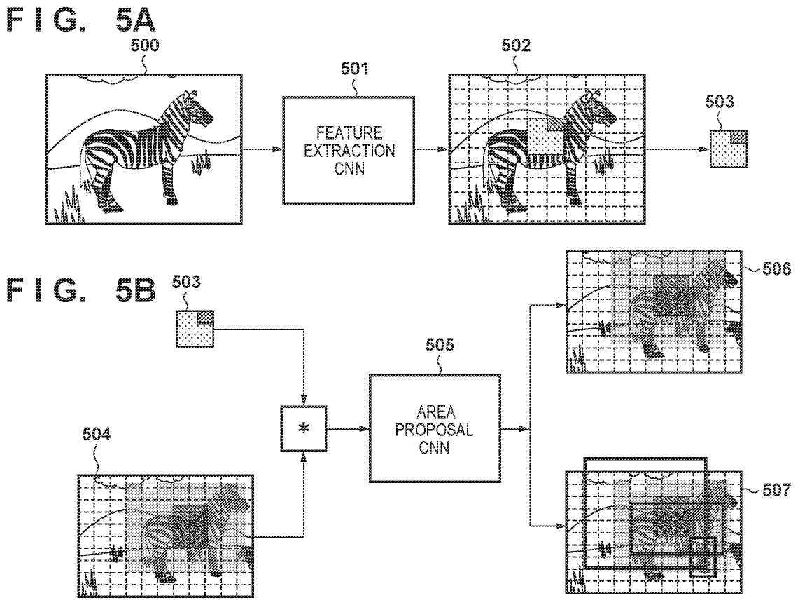

Further, FIG. 5A is a view for describing processing of extracting a template feature amount from the image of interest. The feature amount obtainment unit 103 according to the present embodiment can obtain the template feature amount from the image of interest by processing similar to that of a method described in the Non-Patent Document 2. The feature amount obtainment unit 103 obtains an intermediate feature amount 502 by inputting the image of interest into a CNN 501 trained in advance so as to extract a feature for tracking the subject in the input image. The intermediate feature amount 502 is an output map of the final layer of the CNN 501 or an output map of the intermediate layer. As exemplified in FIG. 5A, a part of the intermediate feature amount 502 (of width 3 and height 3 from the center here) is obtained as a template feature amount 503. Note, the template feature amount is not particularly limited as long as the feature amount used for detection of the subject from the image by the subject detection unit 105 is reflected, and for example, a color histogram, an edge density, or the like may be used.

The candidate calculation unit 104 and the target decision unit 106 extract feature amounts from a search image, and track the subject based on the extracted feature amounts. The candidate calculation unit 104 according to the present embodiment can detect a subject by estimating a position and a size of the subject from an area of interest using an estimation unit (tracking unit) trained so as to estimate the position and size of the subject from the area of interest of each frame in a moving image. Here, it is assumed that the search image is an image of a certain frame included in a moving image that is a processing target for tracking a subject. In the following description, the detection result obtained by tracking the subject is referred to as a “tracking result”.

The candidate calculation unit 104 can output a candidate subject from the search image. The candidate calculation unit 104 according to the present embodiment outputs a similarity map indicating the position of the candidate subject in the search image (based on the likelihood for each position) and a size map indicating the size of the subject. Next, the target decision unit 106 can decide a subject (tracking target) in the search image based on the candidate outputted by the candidate calculation unit 104. Hereinafter, subject decision processing performed by the candidate calculation unit 104 and the target decision unit 106 according to the present embodiment will be described referring to FIG. 5B.

In FIG. 5B, the candidate calculation unit 104 can generate an intermediate feature amount 504 by first inputting the feature amount of the search image into the CNN. Next, the candidate calculation unit 104 inputs a convolution of the generated intermediate feature amount 504 and the template feature amount 503 into a CNN 505, thereby outputting a similarity map 506 and a size map 507. A Fully-Convolutional Network (FCN) described in Non-Patent Document 2 may be used as the CNN 505, or a configuration in which that is combined with a fully-connected layer may be used. Here, the CNN 505 is trained in advance so as to minimize an error between the outputted similarity map 506 and the size map 507 and values given as a supervisory signal.

The target decision unit 106 decides a tracking target based on the tracking target candidates detected by the candidate calculation unit 104. Here, the target decision unit 106 decides the position and size of the subject in the image based on the similarity map 506 and the size map 507. For example, the target decision unit 106 can decide a subject at a position having the highest likelihood value in the similarity map 506 as the subject to be tracked. Any processing by a known tracking method can be used as the decision processing for a tracking target by the target decision unit 106. For example, a tracking target may be selected from and decided upon among a plurality of candidates by using Non-Maximum-Suppression (NMS) or Cosine-window. In addition, the target decision unit 106 may decide a tracking target by integrating subject candidates.

Note that the processing of FIGS. 5A and 5B are merely examples, and if tracking of the subject can be performed based on the search images, the tracking result of the subject can be outputted by a different known tracking processing.

The subject detection unit 105 detects a subject from the area of interest. Also, the subject detection unit 105 can detect a subject by estimating a position and size of the subject from the area of interest using an estimation unit (detection unit) trained so as to estimate the position and size of an object from the area of interest of each frame in a still image. Hereinafter, the detection result of the subject by the detection unit is referred to as a “still image detection result”.

The output of a multilayered neural network of the detection unit according to the present embodiment is a tensor of 12 columns, 8 rows, and 5 channels. A first channel of the tensor is a similarity map indicating a likelihood of a subject for each position on the image corresponding to each element, a second channel indicates a value obtained by inferring an offset amount in the x-direction from each element to the subject center, and a third channel similarly infers an offset amount in the y-direction. A fourth channel of the tensor indicates the width of the subject for each element, and a fifth channel indicates the value in which the height is similarly inferred. From the above five channels of information, the likelihood that the subject exists, the center position, and size can be calculated. This tensor is called an object area candidate tensor.

The multilayered neural network for calculating the object area candidate tensor is trained in advance using a large amount of training data (a set of the width and height of an image and an object, and an offset amount to the center) as described in Non-Patent Document 1. In the present embodiment, a multilayered neural network that simultaneously outputs information of the five channels is used, but if similar information can be obtained, it may be in a different format, and for example, five multilayered neural networks that output one channel at a time may be provided, and the results may be combined. The subject detection unit can detect the subject based on the obtained values of the object area candidate tensor and the coordinates of the designation 404 by the user or a center position 408 of the tracking result.

When the tracking unit (the candidate calculation unit 104) that performs detection based on a moving image is compared with the detection unit (the subject detection unit 105) that performs detection based on a still image, the tracking unit has higher subject position estimation accuracy, while the detection unit has higher subject size estimation accuracy. From such a viewpoint, the subject detection unit 105 detects a subject from an area of interest by the tracking unit, sets the position as a tracking result, detects the subject by the detection unit based on the set position, and estimates the size as a still image detection result.

The candidate calculation unit 104 and the subject detection unit 105 according to the present embodiment output a tracking result and a still image detection result from an area of interest of a certain frame (here, referred to as an (n−1)th frame). Next, the area decision unit 102 according to the present embodiment uses the tracking result and the still image detection result in the (n−1)th frame to decide the area of interest in a frame (here, an n-th frame) which follows the frame.

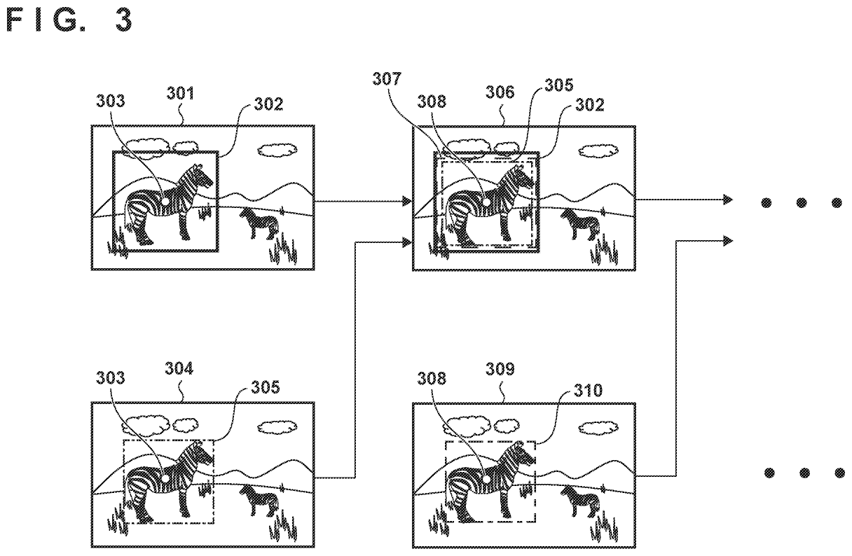

As described above, the processing of deciding the area of interest in the next frame using the tracking result of a certain frame and the still image detection result will be described with reference to FIG. 3. An image 301 and an image 304 are both images captured by the imaging apparatus 110 in an (n−1)th frame, and are the same image except for each piece of information displayed on the image. On the image 301, an area of interest 302 decided from the information of the previous frame (an (n−2)th frame) is indicated by a solid line. The candidate calculation unit 104 according to the present embodiment detects a subject from the area of interest 302, and sets a detected center position 303 of the subject in the area of interest 302.

The detection unit according to the present embodiment detects the subject using the center position 303 set by the tracking unit, and estimates the size of the subject. Here, the detection unit can detect, as the subject, a candidate whose center position is closest to the center position 303 among the candidates of the subject detected from the image 301, for example. Note that, for example, in a case where a similarity map indicating the likelihood of the subject for each position is outputted by the detection unit, the detection unit may attenuate the likelihood according to the distance from the center position 303 and detect a candidate including the position having the highest likelihood as the subject. Here, a still image detection result 305 detected by the detection unit is indicated by a dashed-dotted line.

An image 306 and an image 309 are both images captured by the imaging apparatus 110 in an n-th frame, and are the same image except for the respective information displayed on the images. On the image 306, the area of interest 302, the still image detection result 305, and an area of interest 307 (indicated by a dotted line) of an n-th frame decided by using the area of interest 302 and the still image detection result 305 are displayed. The tracking unit according to the present embodiment detects a subject from the area of interest 307, and sets a detected center position 308 of the subject in the area of interest 307.

Here, the decision processing of the area of interest 307 using the area of interest 302 and the still image detection result 305 by the area decision unit 102 will be described. The area decision unit 102 according to the present embodiment can decide, for example, an area obtained by correcting the area of interest 302 using the still image detection result 305 as the area of interest 307. For example, the area decision unit 102 may use the coordinates obtained by correcting each of the coordinates of the four corners of the area of interest 302 by using the coordinates of the corresponding four corners of the still image detection result 305 as the coordinates of each of the four corners of the area of interest 307.

Here, the area decision unit 102 sets coordinates obtained by averaging each of the coordinates of the four corners of the area of interest 302 and the still image detection result 305 as the coordinates of the four corners of the area of interest 307. Note, the method of determining the area of interest 307 is not particularly limited as described above, and the coordinates obtained by taking a weighted average of each of the coordinates of the four corners of the area of interest 302 and the still image detection result 305 may be decided as the coordinates of the four corners of the area of interest 307. For example, it may be considered that tracking accuracy by a tracking unit of a subject having a predetermined size or less (for example, one side is 30 pixels or less) is significantly reduced due to a deviation of training data or the like. From such a viewpoint, in a case where the size of the subject estimated by the tracking unit is equal to or smaller than a predetermined threshold (which can be arbitrarily set), the area decision unit 102 can set the weight at a time of performing the above-described taking a weighted average so that the still image detection result 305 side becomes heavy. Further, for example, in a case where the similarity map indicating the position of the candidate subject in the search image is generated as the intermediate feature amount 504, the area decision unit 102 may perform the above-described correction according to the value of the similarity map. Also, for example, in a case where the likelihood map indicating the position of the candidate subject in the search image is generated by the subject detection unit 105, the area decision unit 102 may perform the above-described correction according to the value of the similarity map. For example, configuration may be taken such that if the likelihood of the subject position of these similarity maps is equal to or greater than the threshold, correction is not performed, and if the likelihood corresponding to the detection result 403 having the highest Intersection over Union (IoU) from the detection result 403 is equal to or greater than the threshold, correction is performed.

Note that these processes are merely examples, and the method of determining the area of interest 307 is not particularly limited as long as the information on the size of the subject included in the still image detection result 305 is reflected in the area of interest 307. For example, the area decision unit 102 may decide the detection area of the still image detection result as the area of interest as is instead of correcting the area of interest by the weighted averaging as described above.

In a case where the center position 308 is set, the detection unit detects a subject using the center position 308 and estimates the size of the subject. In the image 309, the detection unit detects a still image detection result 310 by processing similar to the detection of the still image detection result 305 in the image 304. The still image detection result 310 is indicated by a dashed-dotted line. In a case where the imaging and detection of the subject are continued, the area of interest in the next frame is decided using the area of interest 307 and the still image detection result 310 by similar processing. Note that since the subject detection processing by the tracking unit and the detection unit can be performed by general moving body detection processing or object detection processing, a detailed description thereof will be omitted.

Note that the processing for deciding the area of interest described with reference to FIG. 3 is considered to be sufficient if it is executed when the accuracy of tracking is insufficient. Therefore, configuration may be taken such that the candidate calculation unit 104 according to the present embodiment decides the subject in the next frame by the processing according to FIG. 3 only in a case where the subject cannot be detected from the area of interest. That is, the candidate calculation unit 104 may determine whether or not the subject can be tracked in the area of interest. Next, the candidate calculation unit 104 may decide the detection area of the subject to be tracked as the area of interest in the next frame in a case where it is determined that the subject can be tracked, and may decide the area of interest by the processing described in FIG. 3 in a case where it is determined that the subject cannot be tracked. In addition, since there is no preceding frame to be referred to in the processing of the first frame, it is assumed that the area of interest is set as the subject detection area.

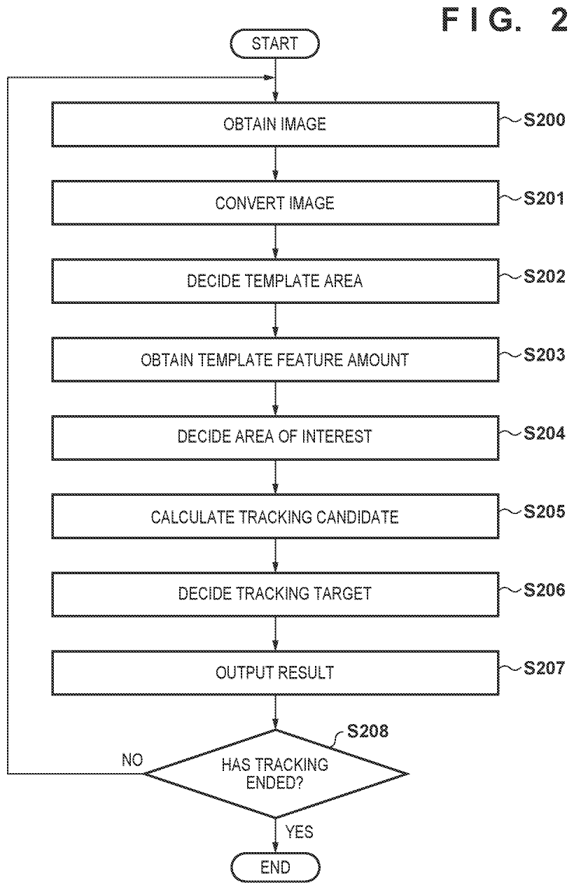

FIG. 2 is a flowchart illustrating an example of information processing performed by the image processing apparatus 100 according to the present embodiment. The processing according to FIG. 2 is realized by the CPU of the image processing apparatus 100 executing a control program. In step S200, the image obtainment unit 101 obtains an image on which the tracking processing will be performed. In the present embodiment, the image obtainment unit 101 obtains the captured image of the n-th frame from the imaging apparatus 110. In step S201, the image obtainment unit 101 converts the image obtained in step S200 for subsequent processing.

Hereinafter, an example of the processing of converting the image in step S201 will be described. Here, it is assumed that the captured image obtained by the imaging apparatus 110 is an RGB image having a width of 6000 pixels and a height of 4000 pixels. The image obtainment unit 101 converts the captured image into a predetermined size. In this example, although the image obtainment unit 101 generates an RGB image having a width of 600 pixels and a height of 400 pixels by conversion, where the size of the captured image is 1/10 in both the vertical and horizontal directions, a different conversion processing may also be performed. For example, the image obtainment unit 101 may further perform padding processing to convert the image size from the captured image to 1/12, or may cut out an area of a predetermined range of the captured image to form a converted image. A converted image the upper-left corner have the coordinates (0, 0) and the position of row j and column i are represented as coordinates (i, j) (in this case, the bottom-right corner is (599, 399)). Hereinafter, the image to be processed refers to the converted image here.

In step S202, the area decision unit 102 sets a template area, which is an area for obtaining the template feature amount. Here, the area decision unit 102 sets one of the areas indicating a candidate of a subject detected from the image by the subject detection unit 105 as the template area. Next, in step S203, the feature amount obtainment unit 103 obtains the template feature amount (503) from the image within the template area.

In step S204, the area decision unit 102 decides an area of interest. Here, in step S200, an image of the n-th frame is obtained, and an area of interest in the image of the n-th frame is decided based on the area of interest decided in the image of the (n−1)th frame and the still image detection result (detected in the processing of step S205 described later).

In FIG. 4B, an area of interest decided by the area decision unit 102 is illustrated. In FIG. 4B, a tracking target 407 decided by the target decision unit 106 and the center position 408 are designated with respect to a past image 406 of an (n−1)th frame. Further, based on the center position 408, the subject detection unit 105 detects the detection result 403 from the past image 406, and in this case, a new area of interest 410 is decided based on the detection result 403 and the tracking result 407.

In step S205, the candidate calculation unit 104 performs tracking (detecting) of the subject based on the area of interest decided in step S204 by the tracking unit. In the present embodiment, the candidate calculation unit 104 generates the similarity map 506 and the size map 507 by using the image of the area of interest decided in step S204 as a search image and inputting the feature amount 504 of the search image and the template feature amount 503 obtained in step S203 to the CNN 501.

In step S206, the target decision unit 106 decides a tracking target in the area of interest based on the tracking result of the subject in step S205. In step S207, the result output unit 120 outputs the tracking result to the external apparatus or the imaging apparatus 110. The tracking result outputted in this way can be used for an AF function, such as a phase-difference AF (autofocus) function by sampling several distance measurement points from the tracking results, for example.

In step S208, the image processing apparatus 100 determines whether or not to end tracking of the subject. When the tracking is ended, the processing according to FIG. 2 is ended, and otherwise, the processing returns to step S200. Here, it is assumed that the tracking of the subject is ended in a case where the imaging operation of the imaging apparatus 110 is stopped by the user, or when a predetermined condition is satisfied, such as when a predetermined time has elapsed since the start of the tracking.

Note that here, according to step S204, the area of interest in the image of the n-th frame is decided based on the area of interest decided in the image of the (n−1)th frame and the still image detection result (detected by the processing of step S205 described later). However, as described above, in a case where tracking of a subject is possible, cases in which it is not necessary to decide the area of interest in this way are conceivable. From such a viewpoint, the candidate calculation unit 104 may determine whether or not the subject can be tracked in the area of interest of the image of the (n−1)th frame. In this case, in step S204, in a case where tracking is possible, the detection area of the subject is decided as the area of interest, and otherwise, the area of interest is decided by the processing described with reference to FIG. 3.

According to such processing, it is possible to decide an area of interest in a frame which follows a certain frame based on a result of an estimation of a position and size of a subject by the tracking unit and a result of an estimation of a position and size of the subject by the detection unit in the area of interest of the certain frame. Therefore, it is possible to improve the tracking accuracy by performing tracking reflecting the detection result by the detection unit that is expected to have higher accuracy of estimation of the size of the subject than the tracking unit. As a result, the area of interest can be decided based on the already obtained tracking and detection results, and the tracking accuracy can be improved even in processing in which real-time performance is required and computation times are limited, as with an AF function.

### Second Embodiment

In the first embodiment, an area of interest in a subsequent frame (n-th frame) is decided by using a tracking result of a certain frame ((n−1)th frame) and a still image detection result. An image processing apparatus 600 according to the present embodiment decides an area of interest in an n-th frame based on a tracking result of the n-th frame, and corrects the tracking result of the n-th frame by the tracking unit from the decided area of interest using a detection result of the n-th frame by the detection unit, thereby deciding the tracking result in the area of interest.

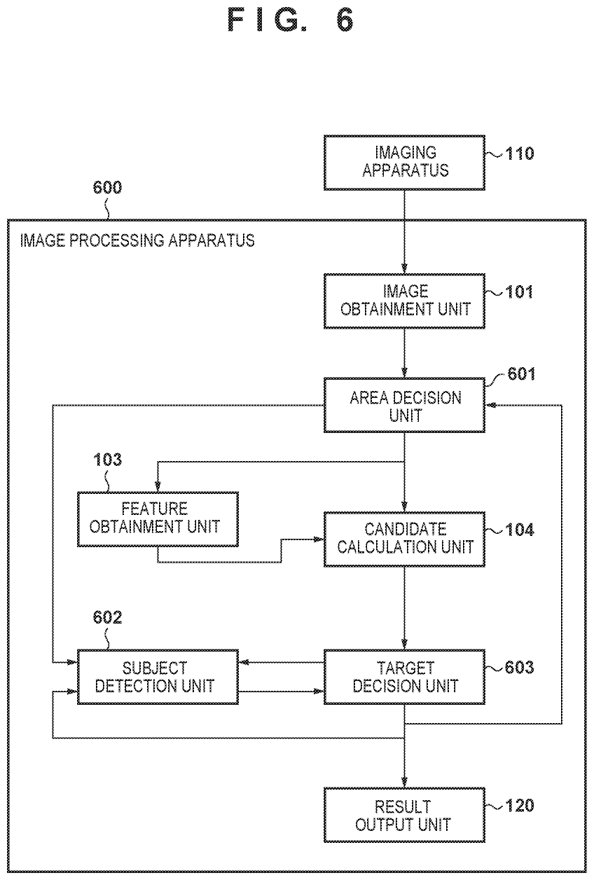

FIG. 6 is a block diagram illustrating an example of a functional configuration of the image processing apparatus 600 according to the present embodiment. The image processing apparatus 600 includes a similar configuration to that of the image processing apparatus 100 of the first embodiment, except that the image processing apparatus 600 includes an area decision unit 601, a subject detection unit 602, and a target decision unit 603 instead of the area decision unit 102, the subject detection unit 105, and the target decision unit 106, respectively. Functional units having the same reference numerals as those in the first embodiment can be processed in the same manner, and a redundant description thereof will be omitted.

The subject detection unit 602 can perform processing similar to that of the subject detection unit 105, and can calculate a candidate subject based on the image obtained from the image obtainment unit 101 and the tracking result of the subject obtained by the target decision unit 603 based on the image of the previous frame. Further, the area decision unit 601 can perform processing similar to that of the area decision unit 102 of the first embodiment, and sets one of the areas indicating the candidate of the subject detected from the image by the subject detection unit 602 as a template area.

The target decision unit 603 corrects the tracking result by the tracking unit of the candidate calculation unit 104 in the image of a certain frame by using the still image detection result by the detection unit of the subject detection unit 602 in the image of the same frame. For example, in a case where the subject is small, the target decision unit 603 may decide the size of the subject not as the value of the size estimated by the tracking unit but as the value of the size estimated by the detection unit, considering that the estimation accuracy of the size is more likely to be higher for the detection unit than for the tracking unit. Further, for example, the target decision unit 603 may set the size of the subject as a value obtained by weighted averaging the size value estimated by the tracking unit and the size value estimated by the detection unit. Note that, although only the size is mentioned here, the value estimated by the detection unit similarly may also be used as the position of the subject.

The target decision unit 603 may decide the position and the size of the subject not as the value estimated by the tracking unit but as the value estimated by the detection unit in accordance with a time-series change in the size of the subject estimated by the tracking unit. Here, for example, the target decision unit 603 may set the value of the size estimated by the detection unit as the value of the size of the subject in a case where the difference between the average value of the size of the subject estimated by the tracking unit in the predetermined period and the size of the subject newly estimated by the detection unit exceeds a fixed value. According to such processing, for example, in cases such as where another subject having a different size is detected as a tracking target by the tracking unit, it is possible to detect an erroneous detection due to a sudden change in size and apply the detection result by the detection unit.

Note that the format of the position and size of the subject calculated here is not particularly limited. For example, the position of the subject estimated by the tracking unit and the position of the subject estimated by the detection unit may be each indicated by the similarity map. That is, as an “estimated size”, values of 0 to 1 in the similarity map may be used.

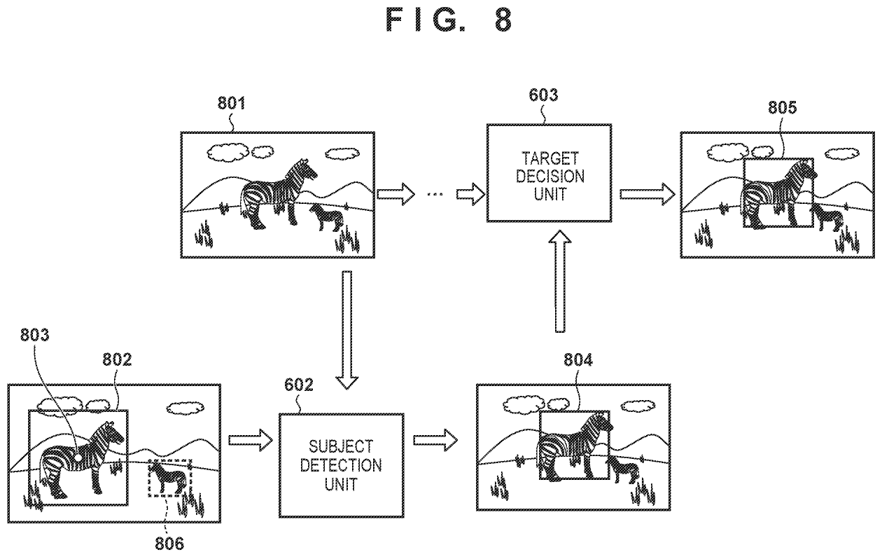

FIG. 8 is a view for describing decision processing of a tracking target performed by the target decision unit 603 according to the present embodiment. The target decision unit 603 decides a tracking result 805 using a captured image 801 and a detection result 804 outputted by the subject detection unit 602 using the captured image 801 as an input. Here, for example, in a case where the tracking unit detects not the subject corresponding to a tracking result 802 but a subject tracking candidate 806 as the tracking target, the position and the size of the subject estimated by the detection unit having higher estimation accuracy of the size can be decided as the tracking target value. Therefore, it is possible to suppress erroneous detection of an obvious subject at first glance.

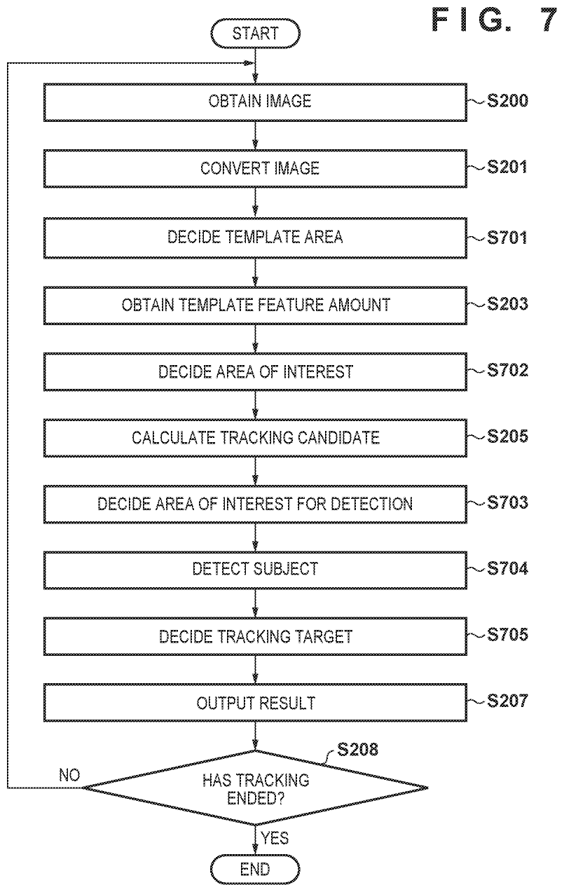

Hereinafter, information processing performed by the image processing apparatus 600 will be described with reference to FIG. 7. FIG. 7 is a flowchart illustrating an example of information processing performed by the image processing apparatus 600 according to the present embodiment. The processing according to FIG. 7 is realized by the CPU of the image processing apparatus 600 executing a control program. In FIG. 7, since step S701, step S702, and step S706 are performed instead of step S202, step S204, and step S206, respectively, and the same processing as in FIG. 2 is performed except that step S703 to step S704 are performed between step S205 and step S704, redundant description will be omitted.

In step S701 following step S201 the area decision unit 601 sets a template area, which is an area for obtaining the template feature amount. Here, the area decision unit 601 sets one of the areas indicating the candidate of the subject outputted based on the image by the subject detection unit 602 and the tracking result of the previous frame as the template area. The post-processing of step S701 proceeds to step S203.

In step S702 following step S203, the area decision unit 601 decides the area of interest. In step S704 following step S703, the area decision unit 601 sets the area of interest decided in step S702 to be used as an area for detecting the subject by the subject detection unit 602 (detection unit) in the image of the same frame (n-th frame). In step S704, the subject detection unit 602 detects a subject from an area of interest of an image of the same frame by the detection unit.

In step S705, the target decision unit 106 decides a tracking target in the area of interest based on the tracking result of the subject in step S205 and the position and size of the subject obtained in step S704.

### Third Embodiment

In the above-described embodiment, each processing unit illustrated in FIG. 1 or the like, for example, is realized by dedicated hardware. However, some or all of the processing units included in the image processing apparatus 100 may be realized by a computer. In the present embodiment, at least a part of the processing according to each of the above-described embodiments is executed by a computer.

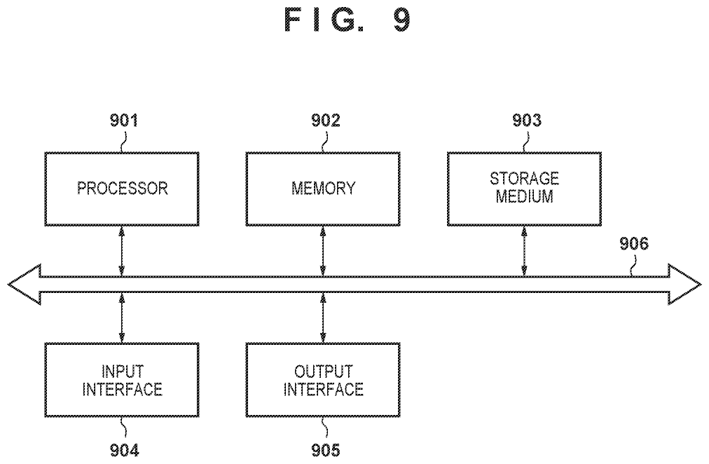

FIG. 9 is a view illustrating a basic configuration of a computer. In FIG. 9, a processor 901 is, for example, a CPU, and controls the operation of the entire computer. A memory 902 is, for example, a RAM, and temporarily stores programs, data, and the like. A computer-readable storage medium 903 is, for example, a hard disk, a CD-ROM, or the like and stores programs, data, and the like over a long period of time. In the present embodiment, a program for realizing the functions of each unit stored in the storage medium 903 is read out to the memory 902. The processor 901 operates in accordance with a program on the memory 902, thereby realizing the functions of the each unit.

In FIG. 9, an input interface 904 is an interface for obtaining information from an external apparatus. Also, an output interface 905 is an interface for outputting information to an external apparatus. A bus 906 connects each of the above-described units and enables data exchange.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-138343, filed Aug. 31, 2022, which is hereby incorporated by reference herein in its entirety.

What is claimed is:

1. An information processing apparatus comprising:
one or more hardware processors; and
one or more memories storing one or more programs configured to be executed by the one or more hardware processors, the one or more programs including instructions for:
first obtaining a position and a size of a subject from an area of interest of a first frame by using a first estimation unit trained so as to estimate a position and a size of a subject from an area of interest of each frame of a moving image;
second obtaining the position and the size of the subject in the first frame that a second estimation unit, which is trained so as to estimate a size and a position of a subject in a still image, has estimated based on the position obtained from the area of interest of the first frame in the first obtaining; and
determining an area of interest in a second frame which follows the first frame by using the position and the size obtained in the first obtaining and the position and the size obtained in the second obtaining.

2. The image processing apparatus according to claim 1, wherein the position and the size of the area of interest in the second frame are determined by correcting the position and the size obtained in the first obtaining with the position and the size obtained in the second obtaining.

3. The image processing apparatus according to claim 2, wherein a value, for which a weighted average of the position and the size obtained in the first obtaining and the position and the size obtained in the second obtaining is taken, is determined as the position and the size of the area of interest in the second frame.

4. The image processing apparatus according to claim 1, wherein, in a case where the size obtained in the first obtaining is lower than or equal to a predetermined threshold, an area of interest in the second frame which follows the first frame is determined by using the position and the size obtained in the first obtaining and the position and the size obtained in the second obtaining.

5. The image processing apparatus according to claim 1, wherein the position obtained in the first obtaining and the position obtained in the second obtaining are indicated by a similarity map showing a likelihood of a subject of each position.

6. The image processing apparatus according to claim 1, wherein
in a case where the subject is not be detected from the area of interest of the first frame by the first estimation unit, an area of interest in the second frame which follows the first frame is determined by using the position and the size obtained in the first obtaining and the position and the size obtained in the second obtaining, and
in a case where the subject is detected from the area of interest of the first frame by the first estimation unit, the position and the size obtained in the first obtaining are determined as the position and the size of the area of interest in the second frame.

7. The image processing apparatus according to claim 1, wherein the one or more programs further include instructions for: determining a position and a size of a subject in the second frame based on a feature amount to be obtained from the still image of the first frame and the area of interest in the second frame.

8. An image processing apparatus comprising:
one or more hardware processors; and
one or more memories storing one or more programs configured to be executed by the one or more hardware processors, the one or more programs including instructions for:
first obtaining a position and a size of a subject from an area of interest of a first frame by using a first estimation unit trained so as to estimate a size and a position of a subject from an area of interest of each frame of a moving image;
second obtaining the position and the size of the subject in the first frame that a second estimation unit trained so as to estimate a size and a position of a subject in a still image has estimated based on the position obtained from the area of interest of the first frame in the first obtaining; and
determining the size and the position of the subject in the first frame by correcting the position and the size obtained in the first obtaining with the position and the size obtained in the second obtaining.

9. The image processing apparatus according to claim 8, wherein the position and the size of the subject in the first frame is determined as the position and the size obtained in the second obtaining.

10. The image processing apparatus according to claim 8, wherein the position of the subject is indicated by a similarity map showing a likelihood of a subject of each position.

11. An information processing method comprising:
obtaining a position and a size of a subject from an area of interest of a first frame by using a first estimation unit trained so as to estimate a position and a size of a subject from an area of interest of each frame of a moving image;
obtaining the position and the size of the subject in the first frame that a second estimation unit, which is trained so as to estimate a size and a position of a subject in a still image, has estimated based on the position obtained by using the first estimation unit from the area of interest of the first frame; and
deciding an area of interest in a second frame which follows the first frame by using the position and the size obtained by using the first estimation unit and the position and the size estimated by the second estimation unit.

12. An image processing method comprising:
obtaining a position and a size of a subject from an area of interest of a first frame by using a first estimation unit trained so as to estimate a size and a position of a subject from an area of interest of each frame of a moving image;
obtaining the position and the size of the subject in the first frame that a second estimation unit trained so as to estimate a size and a position of a subject in a still image has estimated based on the position obtained by the first obtaining unit from the area of interest of the first frame; and
deciding the size and the position of the subject in the first frame by correcting the position and the size obtained by using the first estimation unit with the position and the size estimated by the second estimation unit.

13. A non-transitory computer-readable storage medium storing a program which, when executed by a computer comprising a processor and a memory, causes the computer to:
obtain a position and a size of a subject from an area of interest of a first frame by using a first estimation unit trained so as to estimate a position and a size of a subject from an area of interest of each frame of a moving image;
obtain the position and the size of the subject in the first frame that a second estimation unit, which is trained so as to estimate a size and a position of a subject in a still image, has estimated based on the position obtained by using the first estimation unit from the area of interest of the first frame; and
decide an area of interest in a second frame which follows the first frame by using the position and the size obtained by using the first estimation unit and the position and the size estimated by the second estimation unit.

14. A non-transitory computer-readable storage medium storing a program which, when executed by a computer comprising a processor and a memory, causes the computer to:
obtain a position and a size of a subject from an area of interest of a first frame by using a first estimation unit trained so as to estimate a size and a position of a subject from an area of interest of each frame of a moving image;
obtain the position and the size of the subject in the first frame that a second estimation unit trained so as to estimate a size and a position of a subject in a still image has estimated based on the position obtained by the first obtaining unit from the area of interest of the first frame; and
decide the size and the position of the subject in the first frame by correcting the position and the size obtained by using the first estimation unit with the position and the size estimated by the second estimation unit.
